(19) United States
(12) Patent Application Publication
(10) Pub. No.: US 2003/0046125 A1
(43) Pub. Date: Mar. 6, 2003

(54) System and method for enterprise strategy management

(75) Inventor: David R. Flores, Laguna Beach, CA (US)

Correspondence Address: Brian M. Berliner, O'MELVENY & MYERS LLP, 400 South Hope Street, Los Angeles, CA, 90071-2899, US

(73) Assignee: NextStrat, Inc.

(21) Appl. No.: 09/947,455

(22) Filed: Sep. 5, 2001

(51) Int. Cl. G06F 17/60

(52) U.S. Cl. 705/7

(57) ABSTRACT

An enterprise strategy management system includes a first software module adapted to formulate a strategy description based on an assessment of environmental data, a second software module adapted to align the strategy description with available enterprise resources and deploy strategy implementation responsibilities, and a third software module adapted to measure the execution of the strategy and identify opportunities to optimize strategic performance. The first, second and third software modules are adapted to implement a continuous strategy management cycle, and may be executed in any order. In one embodiment, the first software module is an STRATEGY FORMULATION module, the second software module is an STRATEGY ALIGNMENT module and the third module is an STRATEGY IMPLEMENTATION module. The STRATEGY FORMULATION module includes software components for assessing environmental data, formulating and analyzing strategic alternatives and determining and approving a final strategy description. The STRATEGY ALIGNMENT module includes software components for aligning strategy components, describing and aligning operational strategy components, planning projects, initiatives and performance metrics activity, and deploying implementation responsibilities. The STRATEGY IMPLEMENTATION module includes software components for activating the launch of activities, implementing and measuring the execution of strategy and performance results, and identifying the opportunities to optimize strategic performance.

### BACKGROUND OF THE INVENTION

1. Field of the Invention

The present invention relates generally to the field of strategic planning and, in particular, to a system and method for implementing an enterprise strategy management cycle.

2. Description of the Related Art

Strategy management is critical to the success of many organizations such as businesses, charities, government agencies and schools. Through strategic planning, the leaders of an organization attempt to clarify the organization's long-term goals and develop a strategy for accomplishing those goals. A successful strategy is one that anticipates future threats to the organization and positions the organization to take advantage of new opportunities that may arise.

The strategic planning process is time consuming, expensive and requires a complex analysis of the organization and its environment. As a result, the typical strategic planning process is implemented only once per year and only addresses a small subset of the issues that face the organization. A conventional strategic planning process for a business is illustrated in the diagram of FIG. 1. A strategic planning committee is created from the business' senior management, and the members of the strategic planning committee begin the planning process by conducting an audit of the business and its environment (i.e., an environmental scan) to determine the business' strengths and weaknesses (Step 2). A typical audit involves intensive data gathering from sources throughout the business organization, as well as sources external to the business. Next, the planning committee defines the organization's mission, vision and guiding principles (Step 4). A mission statement describes the present nature of the business, including the business' purpose and direction (i.e., the goals the business is trying to accomplish). A vision statement describes the desired future of the business, and guiding principles outline the values and philosophy of the business that guide the behavior of its personnel.

The planning committee next compares the current state of the business, as determined by the environmental scan and the mission statement, to the business' desired future as identified in the vision statement and guiding principles. Based on this comparison, the planning committee identifies long-term goals, which define the changes the business should implement in order to achieve its stated vision (Step 6). The planning committee selects a manageable number of long-terms goals (e.g., 10) that are reasonable for the business to achieve, and defines strategies for achieving the selected long-term goals. The environmental scan, mission, vision, guiding principles and long-term goals and strategies are compiled into a formal strategic plan, which is used by managers throughout the business to create operating plans directed towards accomplishing the organization's goals (Step 8). Managers and employees then implement the operating plans (Step 10). After creating the formal strategic plan, the planning committee disbands until the following year when a new strategic planning process will start.

The prior art strategic planning processes have many drawbacks. For example, the time, effort and expense required by the strategic planning process limit effective strategic planning to a once-a-year event that addresses only a small number of strategic objectives. Changes in the environment or refinements to the strategic plan are seldom considered until the next year's strategic planning process. As a result, organizations are slow to react to their environments, including environmental changes that may invalidate some of the assumptions underlying the current strategic plan.

To assist with the strategic planning process, many organizations retain large consulting firms. Typically, consultants are retained to guide the planning committee through the strategy formulation process, and leave the implementation of the strategy to the organization. Although consultants may assist in creating more effective strategic plans, they have minimal affect on the extraordinary time, effort and expense required by the strategic planning process.

The use of enterprise software applications has reduced some of the burdens associated with the implementation of the strategic initiatives. Current enterprise software applications such as enterprise resource planning (“ERP”), supply chain management (“SCM”) and customer relationship management (“CRM”) are designed to assist managers in making short-term, day-to-day, operational decisions. However, these applications provide limited and inadequate support for making long-term, strategic decisions. ERP applications provide tools to assist an enterprise in managing and integrating the enterprise's manufacturing, financial and distribution operations in a manner that attempts to optimize the enterprise's resources. These operations may include product-planning, parts purchasing, inventory maintenance, order tracking and human resources. SCM applications provide tools to assist the organization in efficiently managing the enterprise supply chain, including procurement of materials and resources, transformation of these materials and resources into intermediate and finished products and services, and the distribution of these finished products and implementation of these services to customers. CRM applications are used to organize and manage customer information, including information relating to enterprise sales, marketing and services. Although these enterprise applications can be used to assist an organization in efficiently implementing a strategic plan, they do not alleviate the burdens associated with the other aspects of the strategic planning process.

There have been attempts to better integrate enterprise applications into the strategic planning process through the use of balanced scorecard systems, expert systems, knowledge management systems, business intelligence systems and performance management systems. However, these systems only target discrete portions of the strategic planning process and are inadequate to manage strategy across the entire enterprise. For example, many organizations use a balanced scorecard (BSC) system to drive their strategic initiatives. A BSC system focuses on quantitative measures of operational performance, such as customer satisfaction, the success of internal processes and the ability of the organization to adapt to its changing environment. These metrics are used to drive the operating plans in accordance with an already formulated strategic plan. The BSC systems are not used to formulate a strategic plan or solve the other problems inherent in the traditional strategic planning process.

### SUMMARY OF THE INVENTION

The present invention is a system and method for implementing a continuous strategy planning cycle that alleviates many of the burdens of the prior art strategic planning process. In a preferred embodiment, a user device communicates with a web server over one or more communications networks such as the Internet, intranets, local area networks, wireless networks and telephone networks. The web server is connected to an application server that executes applications for managing and implementing an enterprise strategy management application (ESM). The application server is connected to a data storage that stores a plurality of databases used by the ESM. In a preferred embodiment, the application server is also connected to an integration engine, which provides integration services between the ESM and other enterprise applications, such as an enterprise resource planning application, a supply chain management application or a client relationship management application. Through the integration engine, the ESM may share data and reports with other enterprise applications.

In a preferred embodiment, the ESM includes a STRATEGY FORMULATION software module, a STRATEGY ALIGNMENT software module and a STRATEGY IMPLEMENTATION software module. The STRATEGY FORMULATION module includes applications and processes for assisting the organization's management in setting and refining the strategic direction of the organization. In operation, end users utilize the STRATEGY FORMULATION module to assess the organization's internal and external environment, formulate and analyze strategic alternatives and determine and approve a final strategy description. The STRATEGY ALIGNMENT module includes applications and processes for assisting the organization's management in focusing the enterprise on achieving the described strategic goals. In operation, end users utilize the STRATEGY ALIGNMENT module to align described strategy components, describe and align operational strategy components, plan projects, initiatives and performance metrics activity, and deploy implementation responsibilities. The STRATEGY IMPLEMENTATION module includes applications and processes for assisting the organization's management in efficiently distributing and executing the organization's strategy. In operation, end users utilize the STRATEGY IMPLEMENTATION module to the launch of activities, implement and measure the execution of strategy and performance results, and identify opportunities to optimize strategic performance. In a preferred embodiment, the STRATEGY FORMULATION module, STRATEGY ALIGNMENT module and STRATEGY IMPLEMENTATION module interact to create a continuous strategy planning cycle. Unlike the prior art strategic planning processes, the steps in the continuous strategy planning cycle may be executed at any time and in any order, allowing management to take advantage of new opportunities as they arise and refine the strategic plan as problems are presented.

The STRATEGY FORMULATION module preferably includes four software components (ASSESS, FORMULATE, ANALYZE and SELECT) that function as a continuous STRATEGY FORMULATION cycle. The four software components may be executed at any time and in any order. The ASSESS component assists the organization's management in identifying the key forces in both the internal and external environments that may affect the organization in the future and analyzing how these forces affect the current and future of the organization. The FORMULATE component assists the organization's management in creating and articulating alternative strategies for the organization. The ANALYZE component assists the organization's management in reviewing strategic alternatives through the use of analytic methods. The SELECT component assists the organization's management in selecting and finalizing the vision and strategy of the organization.

The STRATEGY ALIGNMENT module preferably includes four components (ALIGN STRATEGY, ALIGN OPERATIONS, PLAN and ASSIGN) that function as a continuous cycle. The four software components may be executed by an end user at any time and in any order. The ALIGN STRATEGY component assists the organization's management in ensuring that the strategic elements of the approved strategy are aligned. In a preferred embodiment, alignment is performed using an alignment matrix that illustrates the relationship between two strategic elements. The ALIGN OPERATIONS component assists the organization's management in ensuring that essential aspects of the organization's operations, technology, and people are aligned with the approved strategy. The PLAN component assists the organization's management in developing plans corresponding to the alignment. The ASSIGN component assists the organization's management in the synchronization, approval and assignment of enterprise initiatives, projects and metrics.

The STRATEGY IMPLEMENTATION module preferably includes four components (LAUNCH, IMPLEMENT, MEASURE and OPTIMIZE) that function as a continuous cycle. The four software components may be executed by an end user at any time and in any order. The LAUNCH component manages the launch of implementation activity for the strategy across the enterprise. The IMPLEMENT component facilitates the day-to-day management of initiatives, projects and metrics. The MEASURE component tracks and reports on the implementation of the organization's strategy. The OPTIMIZE component identifies opportunities and areas for improvement that arise during the execution of the organization's strategy.

A more complete understanding of the System and Method for Enterprise Strategy Management will be afforded to those skilled in the art, as well as a realization of additional advantages and objects thereof, by a consideration of the following detailed description of preferred embodiments. Reference will be made to the appended sheets of drawings, which will first be described briefly.

### BRIEF DESCRIPTION OF THE DRAWINGS

FIG. 1 is a flow diagram illustrating a prior art strategic planning process;

FIG. 2 illustrates a preferred environment for an enterprise strategy management system;

FIG. 3 illustrates a preferred embodiment of an enterprise strategy management application;

FIG. 4 illustrates a preferred embodiment of the software modules of an enterprise strategy management application;

FIGS. 5a-d illustrate a preferred data flow of the software components of a STRATEGY FORMULATION module;

FIGS. 6a-d illustrate a preferred data flow of the software components of a STRATEGY ALIGNMENT module;

FIG. 7 illustrates a preferred embodiment of an alignment matrix; and

FIGS. 8a-d illustrate a preferred data flow of the software components of a STRATEGY IMPLEMENTATION module.

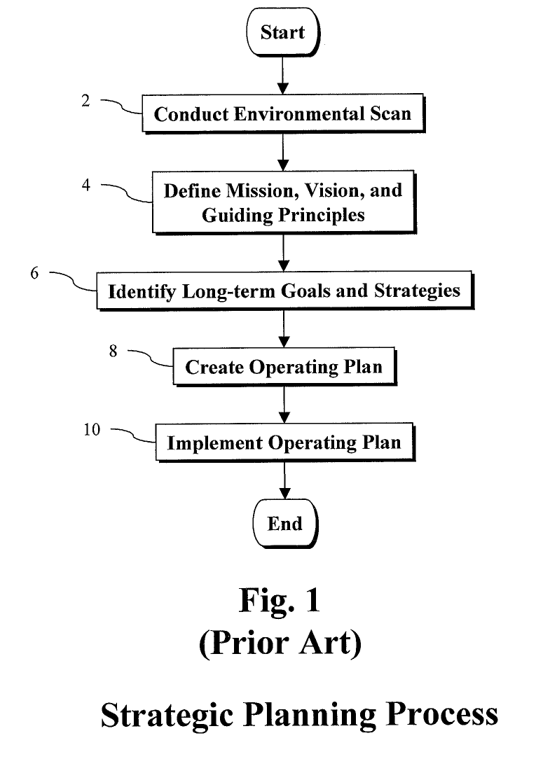

### DESCRIPTION OF A PREFERRED EMBODIMENT

In a preferred embodiment of the present invention, an enterprise strategy management application drives the entire lifecycle of an organization's strategy from vision to execution. In the detailed description of a preferred embodiment that follows, like element numerals are used to describe like elements illustrated in one or more the aforementioned figures.

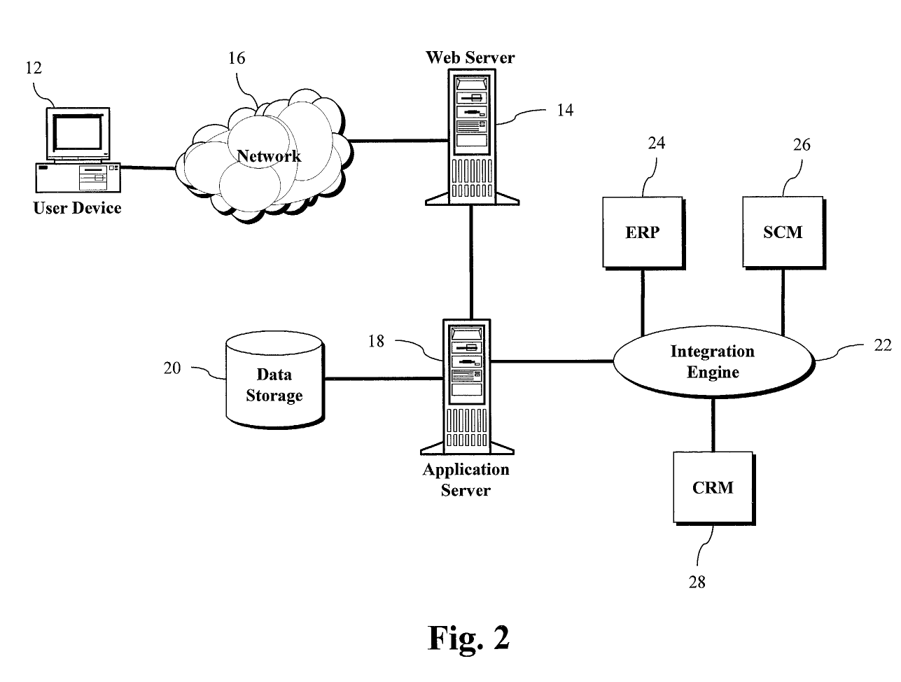

A preferred operating environment for an enterprise strategy management application (ESM) is illustrated in FIG. 2. At least one user device 12 is adapted to communicate with at least one web server 14 through a network 16. The network 16 may include one or more communications networks that facilitate communications between the user device 12 and the web server 14, such as the Internet, intranets, local area networks, wireless networks and telephone networks. In a preferred embodiment, the user device 12 is a personal computer. However, the user device 12 may be any device that is adapted to communicate with the web server 14, such as a personal digital assistant, wireless application protocol telephone or television set-top box. The web server 14 preferably includes one or more World Wide Web servers that are adapted to serve content to the user device 12 through web browser software executing on the user device 12.

The web server 14 is connected to an application server 18, preferably through a local area network. In a preferred embodiment, the application server 18 is a JAVA application server that executes applications for managing and implementing the enterprise strategy management application. The application server 18 is connected to a storage system 20 that stores a plurality of databases used by the ESM. The storage system 20 may include a database server, a storage area network, one or more network attached storage devices or any other data storage device or system that is capable of storing ESM data. The application server 18 is preferably connected to an integration engine 22, which provides integration services between the ESM and other enterprise applications, such as an enterprise resource planning application 24, a supply chain management application 26 or a client relationship management application 28. The integration engine 22 may execute on the application server 18 and/or one or more other servers connected to the application server 18. Through the integration engine 22, the ESM shares data and reports with other enterprise applications.

It should be appreciated that the operating environment described in FIG. 2 is merely illustrative and that alternative network and server configurations are contemplated within the scope and spirit of the present invention. For example, in alternative embodiments the functions performed by the data storage 20, application server 18 and web server 14 may be performed by a single computer system or by a plurality of computer systems distributed across any number of locations.

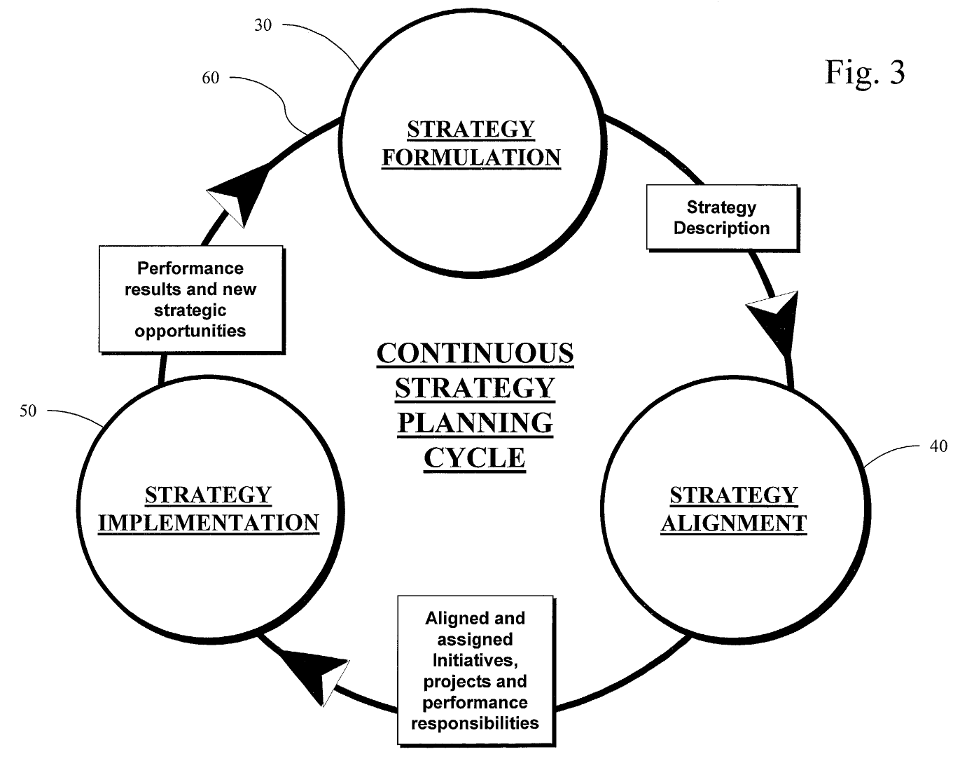

The ESM will now be described with reference to FIG. 3. In a preferred embodiment, the ESM is a software application that includes a STRATEGY FORMULATION software module 30, a STRATEGY ALIGNMENT software module 40 and a STRATEGY IMPLEMENTATION software module 50. The STRATEGY FORMULATION module 30 includes applications and processes for assisting the organization's management in setting and refining the strategic direction of the organization. In operation, end users utilize the STRATEGY FORMULATION module 30 to assess the internal and external environment including performance results and newly identified strategic opportunities, formulate and analyze strategic alternatives and determine and approve a final strategy description. The STRATEGY ALIGNMENT module 40 includes applications and processes for assisting the organization's management in focusing the entire enterprise on achieving the described strategic goals. In operation, end users utilize the STRATEGY ALIGNMENT module 40 to align the described strategy components, describe and align operational strategy components, plan projects, initiatives and performance metrics activity, and deploy implementation responsibilities. The STRATEGY IMPLEMENTATION module 50 includes applications and processes for assisting the organization's management in efficiently distributing and executing the organization's strategy. In operation, end users utilize the STRATEGY IMPLEMENTATION module 50 to activate the launch of activities, implement and measure the execution of strategy and performance results, and identify the opportunities to optimize strategic performance.

As will be described in greater detail below, the STRATEGY FORMULATION module 30, the STRATEGY ALIGNMENT module 40 and the STRATEGY IMPLEMENTATION module 50 interact to drive a continuous strategy planning cycle 60 that offers many advantages over the prior art. Unlike the prior art, the STRATEGY FORMULATION module 30 provides a computer-implemented process for formulating strategy and the STRATEGY ALIGNMENT module 40 provides a computer-implemented process for aligning strategy with organizational resources. In addition, the continuous strategy planning cycle 60 provides a framework that allows for the efficient management and implementation of a larger number of strategic objectives than is practical under a traditional strategy planning approach. Unlike the prior art, the steps in the continuous strategy planning cycle 60 may be executed at any time and in any order, allowing the organization to take advantage of opportunities as they arise and refine different aspects of the strategic plan as problems are presented. In addition, the continuous strategy planning cycle 60 provides a framework to allow refinements to be made across multiple strategy planning cycles. This allows an organization to select more ambitious strategic objectives (including strategic objectives that may not appear achievable) than would be practical to implement under the prior art approaches. Additional advantages of the present invention should be readily apparent to persons having ordinary skill in the art.

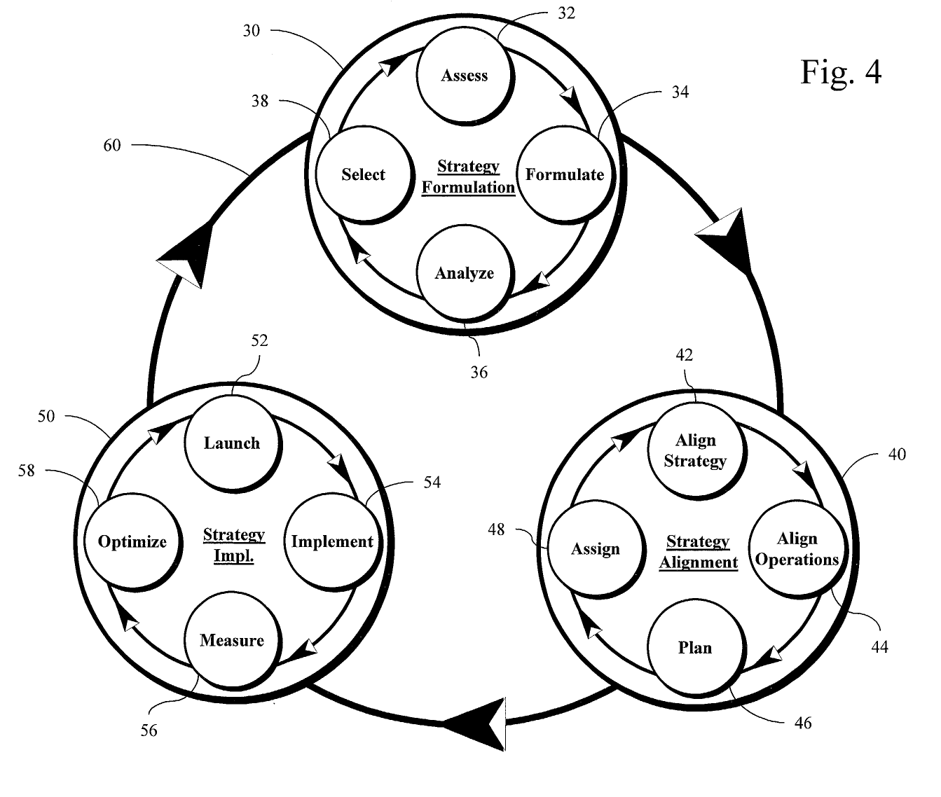

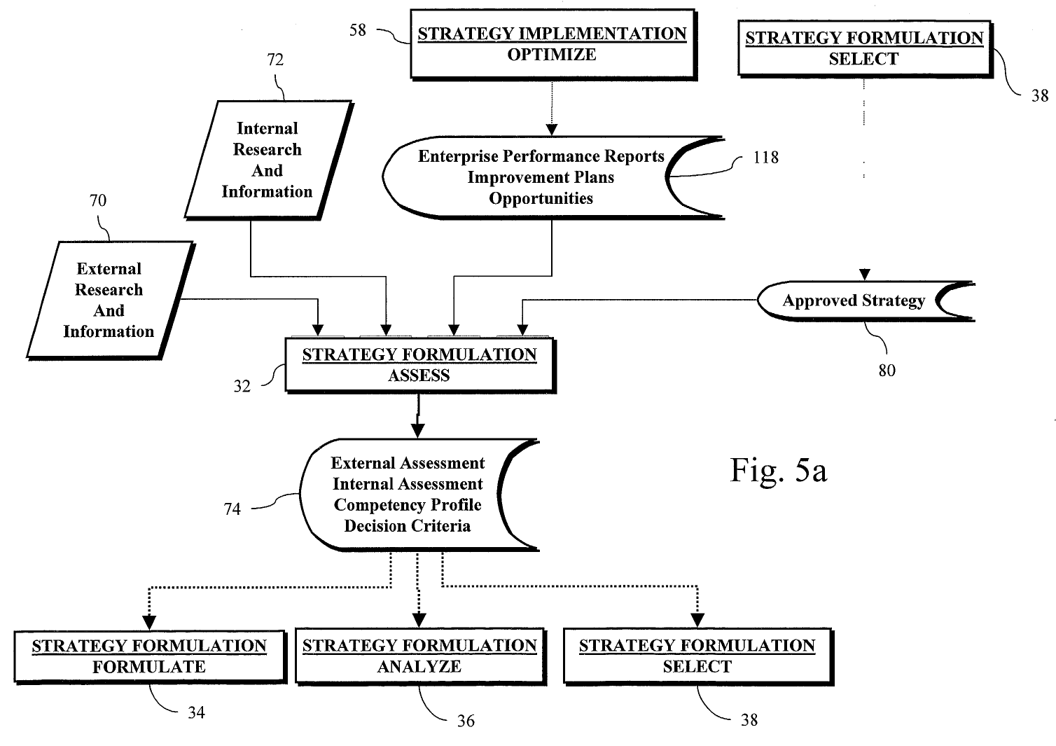

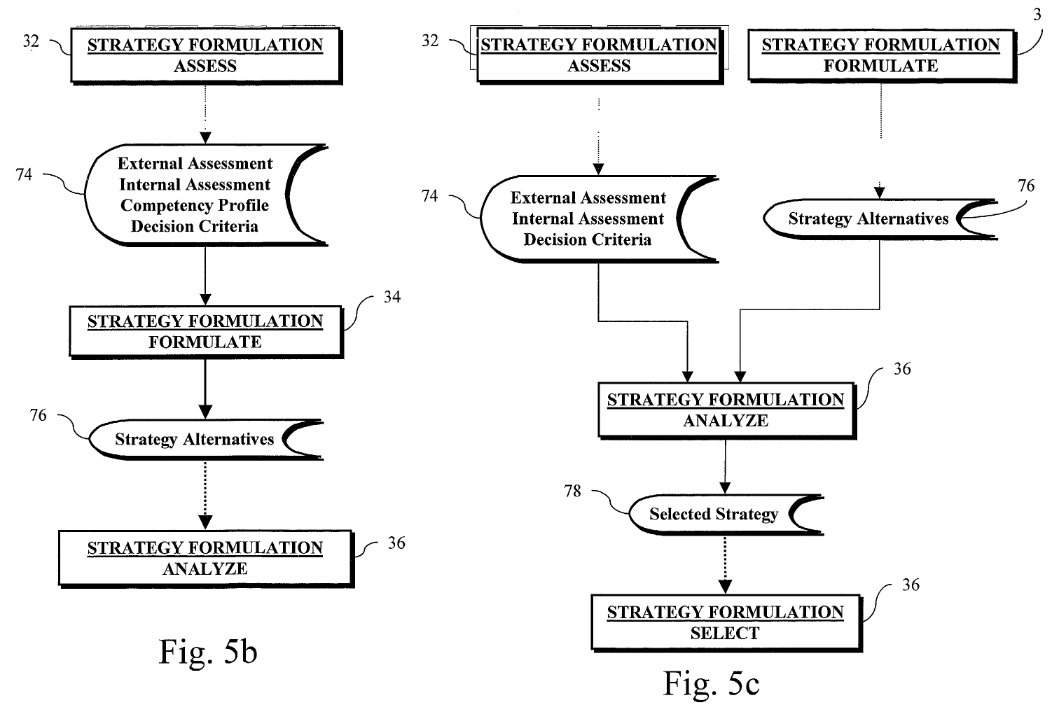

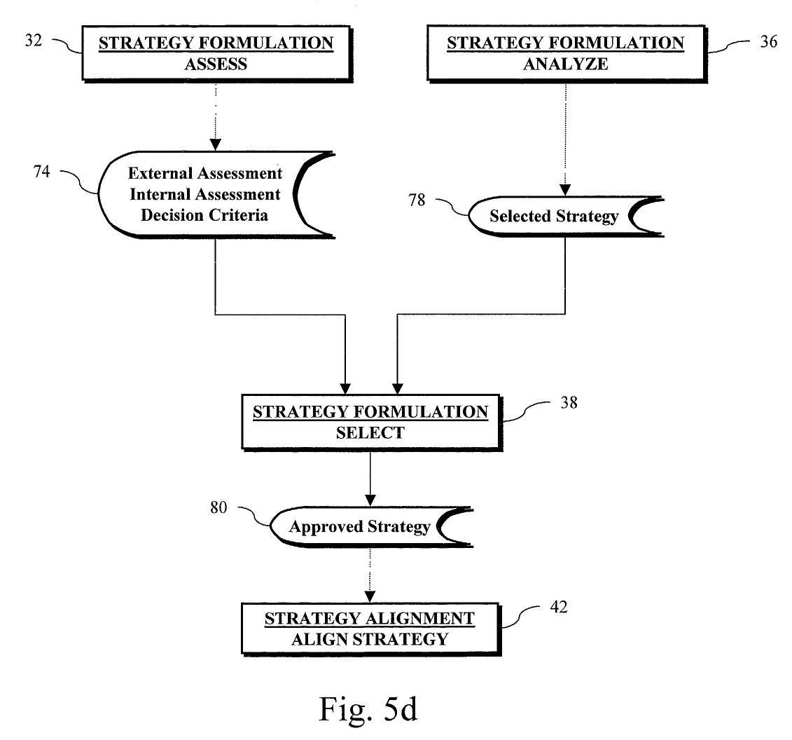

As illustrated in FIG. 4, the STRATEGY FORMULATION module 30 preferably includes four software components: ASSESS 32, FORMULATE 34, ANALYZE 36 and SELECT 38. The software components of the STRATEGY FORMULATION module 30 interact to function as a continuous strategy formulation cycle and may be executed by end users at any time and in any order. A preferred embodiment of the ASSESS component 32 is illustrated in FIG. 5a. The ASSESS component 32 includes processes for assisting the organization's management in identifying and analyzing the key forces in both the internal and external environments that may affect the organization in the future. The ASSESS component 32 analyzes environmental data from external research/information 70 (e.g., market data obtained from third-party research firms), internal research/information 72 (e.g., data received from other enterprise applications through the integration engine), the current approved strategy 80 (produced by the SELECT component 38) and enterprise performance information 104 (produced by the STRATEGY IMPLEMENTATION module 50 from a prior strategy planning cycle) using techniques of environmental scanning and competitive intelligence. In the preferred embodiment, the data used by the modules and components of the ESM may be accessed through the storage system 20 (see FIG. 2). Based on the analysis of the input data, the ASSESS module 32 generates output data 74, including an external environmental assessment, an internal environmental assessment, a competency profile of the organization and decision criteria. The output data 74 may be produced using conventional analytical approaches such as Strength, Weakness, Opportunity & Threat Analysis (SWOT Analysis) and internal Value Chain Analysis.

A preferred embodiment of the FORMULATE component 34 is illustrated in FIG. 5b. The FORMULATE component 34 includes processes for assisting the organization's management in creating and articulating alternative strategies for the organization. The FORMULATE component 34 retrieves the external assessment, internal assessment, competency profile and decision criteria 74 generated by the ASSESS module 32 and analyzes the data to formulate strategy alternatives 76. The strategy alternatives 76 may be produced using a conventional approaches and concepts such as Five-Forces Competitive Analysis and Strategic Groups.

A preferred embodiment of the ANALYZE component 36 is illustrated in FIG. 5c. The ANALYZE component 36 includes processes for assisting the organization's management in analyzing the strategic alternatives prepared by the FORMULATE component 34. The ANALYZE component 36 also retrieves the external assessment, internal assessment and decision criteria 74 generated by the ASSESS component 32. In a preferred embodiment, the analysis of the strategy alternatives includes a risk analysis and an assignment of a score for each strategic alternative based on the decision criteria. This may be accomplished using conventional approaches as known in the art. After analyzing the strategic alternatives, the end user may select one of the strategy alternatives 78 for implementation.

A preferred embodiment of the SELECT component 38 is illustrated in FIG. 5d. The SELECT component 38 includes processes for assisting the organization's management in selecting and finalizing the vision and strategy of the organization. The SELECT component 38 retrieves the external assessment, internal assessment and decision criteria 74 generated by the ASSESS component 32 and the selected strategy 78 generated by the ANALYSIS component 36. Through the SELECT component 38, the end user creates a detailed strategy specification and approves the finalized strategy 80. In a preferred embodiment, the finalized strategy 80 may be generated through one or more end user applications that assist the end user in defining and describing the organization's strategy in relation to the product and service it offers and the market segments the organization is targeting.

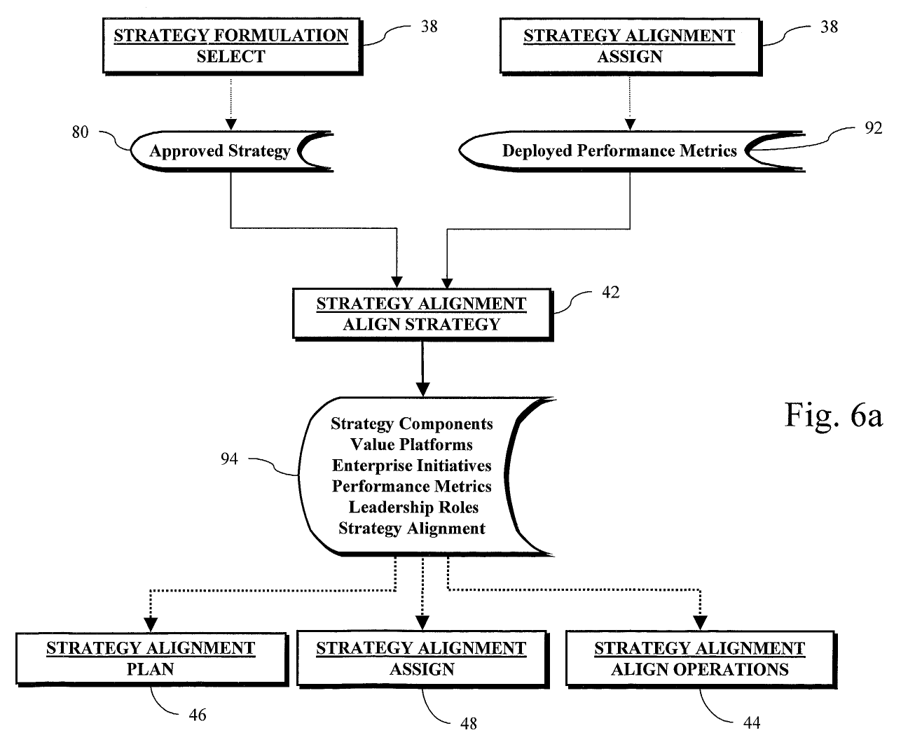

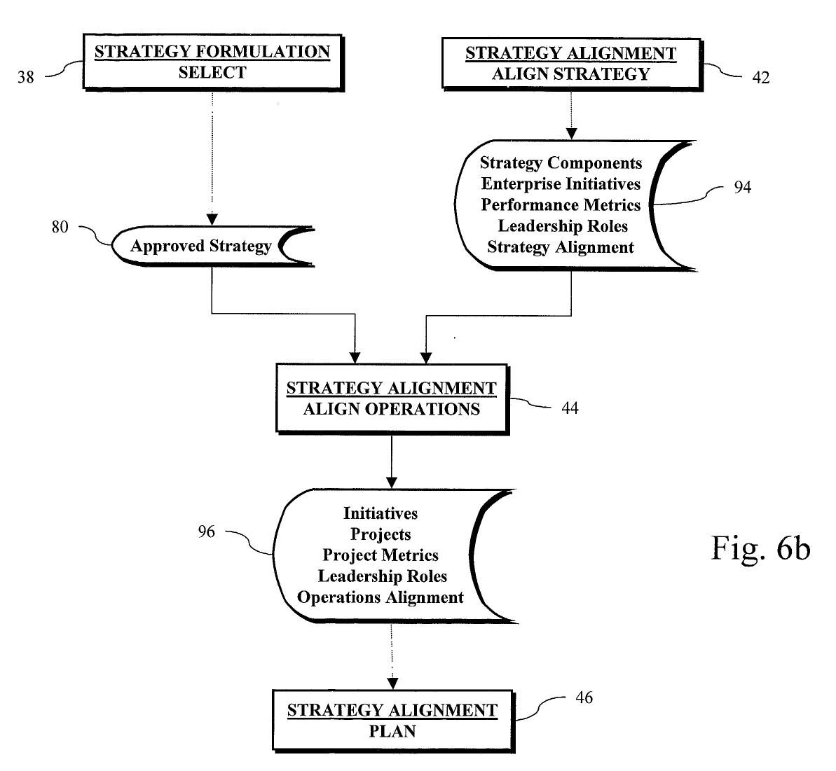

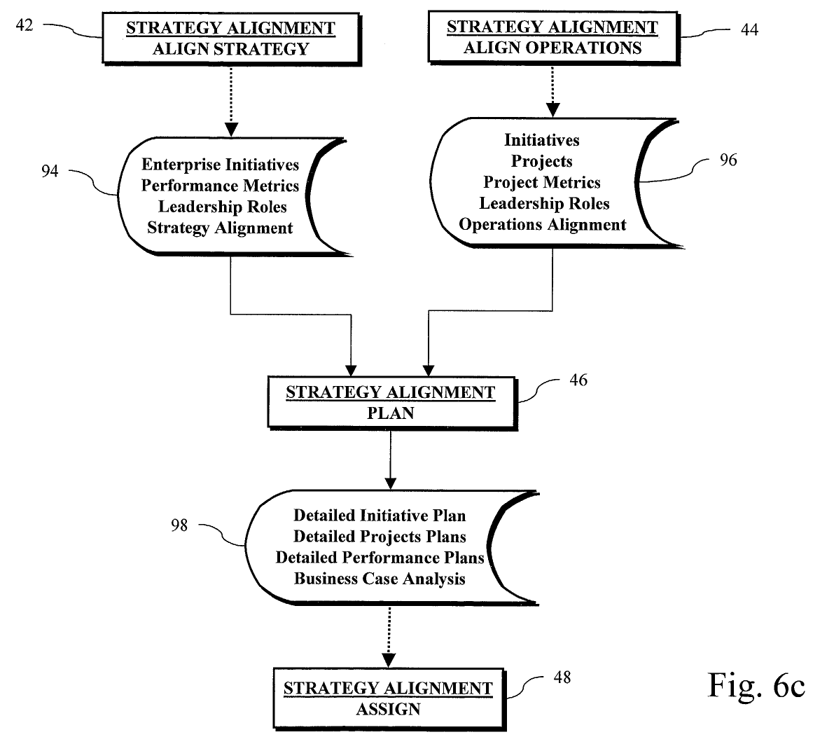

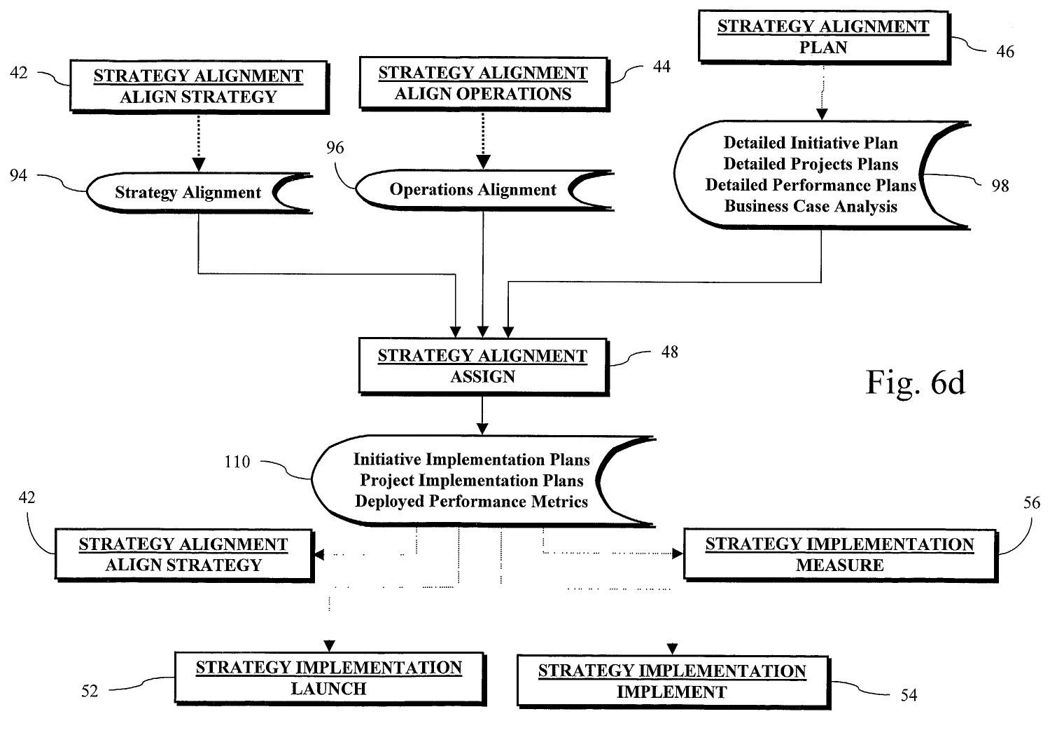

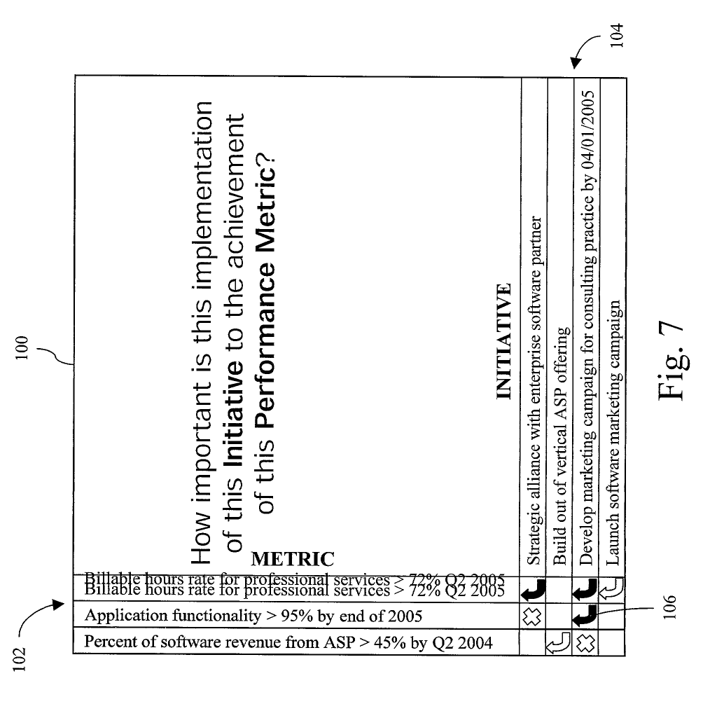

Referring back to FIG. 4, a preferred embodiment of the STRATEGY ALIGNMENT module 40 includes four components: ALIGN STRATEGY 42, ALIGN OPERATIONS 44, PLAN 46 and ASSIGN 48. The software components of the STRATEGY ALIGNMENT module 40 function as part of a continuous cycle and may be executed by an end user at any time and in any order. A preferred embodiment of the ALIGN STRATEGY component 42 is illustrated in FIG. 6a. The ALIGN STRATEGY component 42 retrieves the approved strategy 80 that was generated by the SELECT component 38 of the STRATEGY FORMULATION module 30, as well as deployed performance metrics 92 previously generated by the ASSIGN component 48. The ALIGN STRATEGY component 42 is used by the organization's managers to ensure that the strategic elements of the approved strategy are aligned. The ALIGN STRATEGY component 42 outputs data describing the strategy alignment and strategic elements 94, such as the organization's initiatives, value platforms, performance metrics and leadership roles. The ALIGN STRATEGY component 42 may be implemented using conventional concepts of project management. FIG. 7 illustrates a preferred input screen 100 for use by managers in aligning strategic elements, such as enterprise initiatives and performance metrics. As illustrated, each metric is listed in a column 102 and each initiative is listed in a row 104. The end user utilizes the intersection between the columns 102 and the rows 104 (alignment matrix) to define the relationship between each metric and each initiative. In one embodiment, a symbol 106 is placed at the intersection of a metric and each initiative it supports. Preferably, a plurality of symbol types are used, such as arrows and “x”s, to further describe the relationship between the metric and initiatives support.

A preferred embodiment of the ALIGN OPERATIONS component 44 is illustrated in FIG. 6b. The ALIGN OPERATIONS component 44 retrieves the approved strategy 80 that was generated by the SELECT component 38 of the STRATEGY FORMULATION module 30, as well as the strategy components, enterprise initiatives, performance metrics, leadership roles and strategy alignment data 94 generated by the ALIGN STRATEGY component 42. The ALIGN OPERATIONS component 44 assists the organization's management in ensuring that essential aspects of the organization's operations, technology, and people are aligned with the approved strategy. The data 96 produced by the ALIGN OPERATIONS component 44 includes operational elements such as operations initiatives and projects, project metrics and leadership roles, as well as complete operations alignment data. The ALIGN OPERATIONS component 44 may be implemented using conventional project management concepts to integrate operational elements with the selected strategy. In a preferred embodiment, the operational elements are aligned by managers using an alignment matrix as illustrated in FIG. 7.

A preferred embodiment of the PLAN component 46 is illustrated in FIG. 6c. The PLAN component 46 retrieves the strategy alignment, operational alignment, initiatives, projects, performance metrics and leadership roles 94 and 96 generated by the ALIGN STRATEGY component 42 and the ALIGN OPERATIONS component 44, respectively. The PLAN component 46 assists the organization's management in developing plans corresponding the approved strategy and alignments. In a preferred embodiment, the ALIGN OPERATIONS component 44 produces data 98 including detailed plans for initiatives, projects and performance, and a business case analysis. The ALIGN OPERATIONS component 44 may be implemented using conventional project planning methods.

A preferred embodiment of the ASSIGN component 48 is illustrated in FIG. 6d. The ASSIGN component 48 retrieves the strategy alignment data 94 generated by the ALIGN STRATEGY component 42, the operations alignment data 96 generated by the ALIGN OPERATIONS component 44, and the business case analysis and detailed plans for initiatives, projects and performance data 98 generated by PLAN 46. The ASSIGN component 48 assists the organization's management in the synchronization, approval and assignment of enterprise initiatives, projects and metrics. In a preferred embodiment, the output data 110 including initiative implementation plans, project implementation plans and deployed performance metrics are generated by the ASSIGN component 48. The output data 110 may be generated using conventional approaches as known in the art.

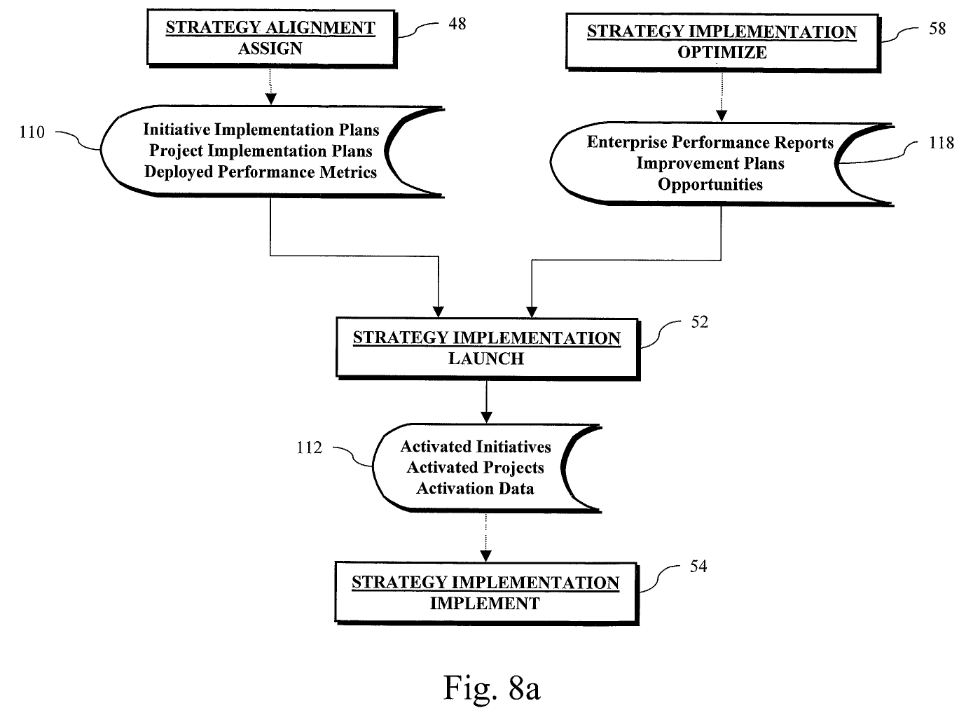

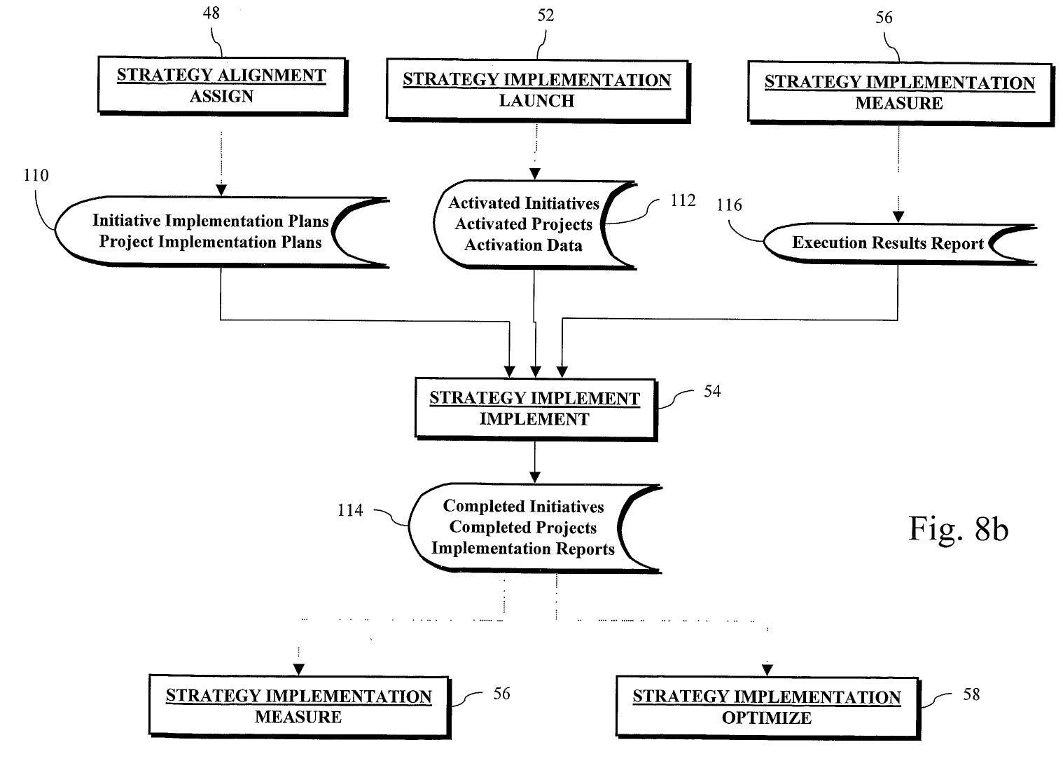

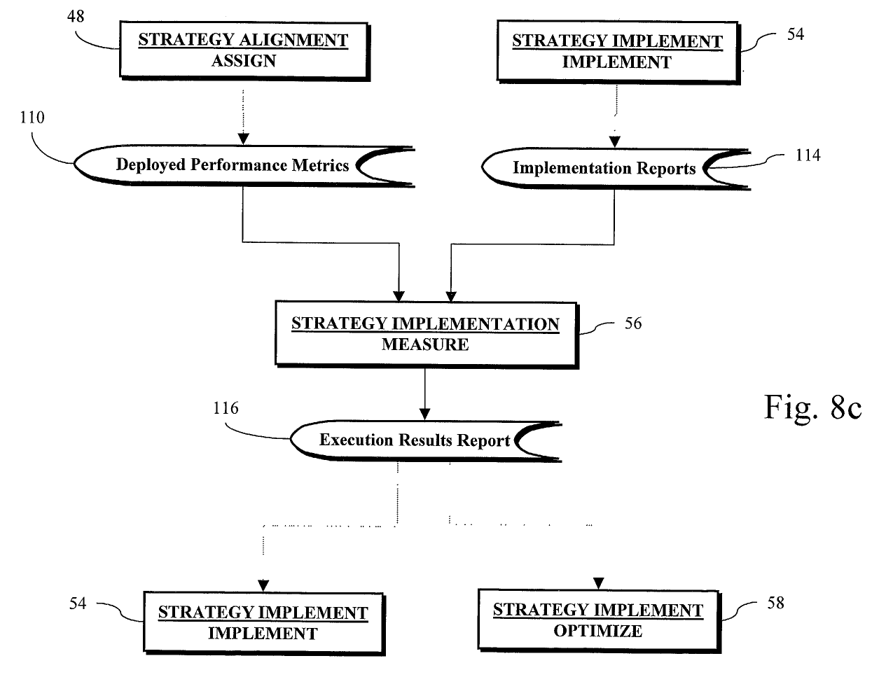

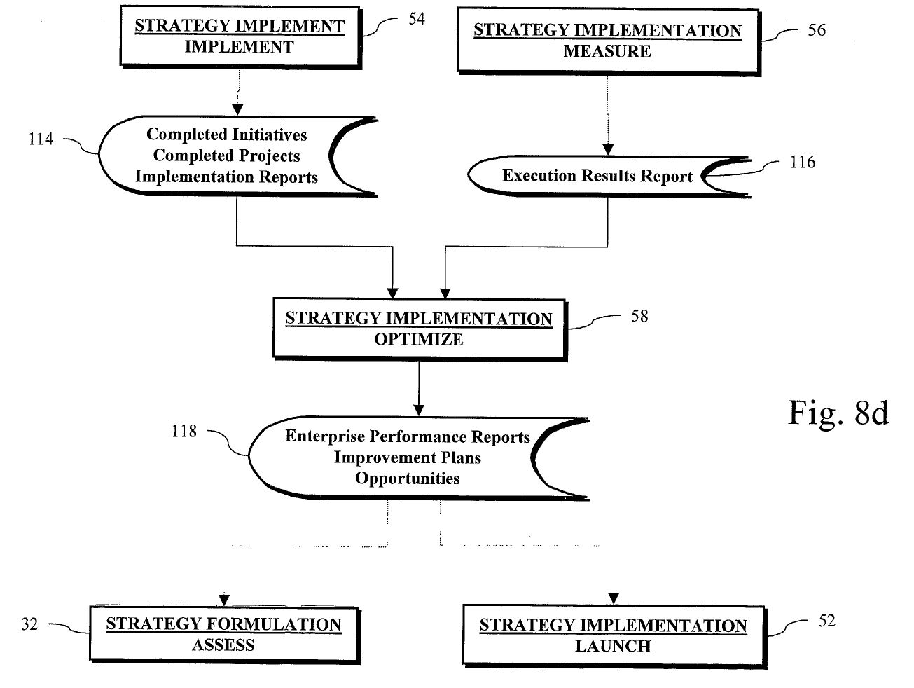

Referring back to FIG. 4, a preferred embodiment of the STRATEGY IMPLEMENTATION module 50 includes four components: LAUNCH 52, IMPLEMENT 54, MEASURE 56 and OPTIMIZE 58. The software components of the STRATEGY IMPLEMENTATION module 50 function as part of a continuous cycle and may be executed by an end user at any time and in any order. A preferred embodiment of the LAUNCH component 52 is illustrated in FIG. 8a. The LAUNCH component 52 retrieves the initiative implementation plans, project implementation plans and deployed performance metrics data 110 generated by the ASSIGN component 48 of the STRATEGY ALIGNMENT module 40. In addition, the LAUNCH component 52 retrieves data 118, including enterprise performance reports, improvement plans and identified opportunities, previously generated by the OPTIMIZE component 58. End users use the LAUNCH component 52 to manage the launch of implementation activity for the enterprise strategy. The LAUNCH component 52 generates a status list of activated initiatives, activated projects and other related data 112.

A preferred embodiment of the IMPLEMENT component 54 is illustrated in FIG. 8b.The IMPLEMENT component 54 retrieves the initiative implementation plans and project implementation plans 110 generated by the ASSIGN component 48 of the STRATEGY ALIGNMENT module 40, the activated initiatives, activated projects and other related data 112 generated by the LAUNCH component 52, and an execution results report 116 previously generated by the MEASURE component 56. The IMPLEMENT component 54 assists managers in facilitating the day-to-day management of initiatives, projects and metrics. The IMPLEMENT component 54 maintains data 114 on completed initiatives, completed projects and implementation.

A preferred embodiment of the MEASURE component 56 is illustrated in FIG. 8c. The MEASURE component 56 retrieves the deployed performance metrics 110 generated by the ASSIGN component 48 of the STRATEGY ALIGNMENT MODULE 40, and implementation reports 114 from the IMPLEMENT component 54. The MEASURE component 56 includes application tools for reporting and tracking the implementation of the organization's strategy and produces an execution results report 116. The MEASURE component 56 may be implemented using conventional performance measurement approaches such as a Balanced Score Card.

A preferred embodiment of the OPTIMIZE component 58 is illustrated in FIG. 8d. The OPTIMIZE component 58 is adapted to receive completed initiatives, completed projects and implementation reports 114 from the IMPLEMENT component 54, and the execution results report 116 generated by the MEASURE component 56. The OPTIMIZE component 58 provides application tools for managers to use in identifying opportunities and areas for improvement that arise during the execution of the organization's strategy. The OPTIMIZE component 58 produces output data 118 such as enterprise performance reports, improvement plans and lists of opportunities. The OPTIMIZE component 58 may be implemented using feedback loop concepts to match opportunities with resources.

Having thus described a preferred embodiment the System and Method for Enterprise Strategy Management, it should be apparent to those skilled in the art that certain advantages of the within described system have been achieved. It should also be appreciated that various modifications, adaptations, and alternative embodiments thereof may be made within the scope and spirit of the present invention. For example, in the preferred embodiment the ESM includes three software modules, each of which includes four software components. However, it should be apparent to those skilled in the art that the present invention may be implemented with a different number of modules and components.

The scope of the present invention is defined by the following claims.

What is claimed is:

1. An enterprise strategy management system comprising:
a first software module adapted to formulate a strategy description based on an assessment of environmental data;
a second software module adapted to align the strategy description with available enterprise resources and deploy strategy implementation responsibilities; and
a third software module adapted to measure the performance of the strategy and identify opportunities to optimize strategic performance.

2. The enterprise strategy management system of claim 1 wherein the first, second and third software modules are adapted to implement a continuous strategy management cycle.

3. The enterprise strategy management system of claim 1 wherein environmental data includes performance measures and identified opportunities generated by the third software module.

4. The enterprise strategy management system of claim 2 wherein the software modules are adapted for execution in any order.

5. The enterprise strategy management system of claim 1 wherein the first software module is a STRATEGY FORMULATION module.

6. The enterprise strategy management system of claim 1 wherein the second software module is a STRATEGY ALIGNMENT module.

7. The enterprise strategy management system of claim 1 wherein the third software module is a STRATEGY IMPLEMENTATION module.

8. The enterprise strategy management system of claim 1 wherein the first software module is further adapted to analyze strategic alternatives and determine a final strategy decision.

9. A computer-implemented method for enterprise strategy management comprising the steps of:
formulating a strategy based on an assessment of environmental data;
aligning the strategy with available enterprise resources;
implementing the strategy in accordance with the alignment; and
identifying new strategic opportunities;
wherein the steps of formulating, aligning, implementing and identifying are repeated to form a continuous strategy management cycle.

10. The computer-implemented method of claim 9 wherein the steps may be executed in any order.

11. The computer-implemented method of claim 9 further comprising the steps of:
analyzing a plurality of strategic alternatives; and
selecting one of the plurality of strategic alternatives for implementation.

12. The computer-implemented method of claim 9 further comprising the step of integrating enterprise data into the environmental data.

13. An enterprise strategy management application comprising:
A STRATEGY FORMULATION software module;
an STRATEGY ALIGNMENT software module; and
A STRATEGY IMPLEMENTATION software module;
wherein the STRATEGY FORMULATION, STRATEGY ALIGNMENT and STRATEGY IMPLEMENTATION software modules implement a continuous strategic planning cycle.

14. The enterprise strategy management application of claim 13 wherein the STRATEGY ALIGNMENT software module comprises an alignment matrix.

15. The enterprise strategy management application of claim 13 wherein the STRATEGY FORMULATION software module comprises:
an ASSESS software component;
an ANALYZE software component;
a SELECT software component; and
a FORMULATE software component.

16. The enterprise strategy management application of claim 13 wherein the STRATEGY ALIGNMENT software module comprises:
an ALIGN STRATEGY software component;
an ALIGN OPERATIONS software component;
a PLAN software component; and
an ASSIGN software component.

17. The enterprise strategy management application of claim 13 wherein the STRATEGY IMPLEMENTATION software module comprises:
an LAUNCH software component;
a MEASURE software component;
an OPTIMIZE software component; and
an IMPLEMENT software component.

18. In an enterprise strategy management system, a method for aiming the enterprise towards a long-term strategic goal comprising the steps of:
assessing the internal and external environment;
formulating strategic alternatives based on the environmental assessment;
comparing the formulated strategic alternatives;
determining a final strategy description; and
approving a final strategy solution.

19. In an enterprise strategy management system, a method for aligning a strategy with available enterprise resources comprising the steps of:
aligning strategy components;
describing operational strategy components;
aligning operational strategy components;
planning projects, initiatives and performance metrics activity; and
deploying implementation responsibilities.

20. In an enterprise strategy management system, a method for acting in accordance with a strategic plan comprising the steps of:
activating the launch of activities;
implementing and measuring the execution of strategy and performance results; and
identifying the opportunities to optimize strategic performance.
